(19) United States
(12) Patent Application Publication
(10) Pub. No.: US 2006/0164614 A1
(43) Pub. Date: Jul. 27, 2006

(54) Exposing machine for a printed circuit board

(76) Inventors: Hua-Kuo Chen, Sinjhuang City (TW); Hua-Ming Chen, Sinjhuang City (TW)

Correspondence Address: Hua-Kuo CHEN & Hua-Ming CHEN, P.O. Box No. 6-57, Junghe, Taipei, 235, TW

(21) Appl. No.: 11/038,198

(22) Filed: Jan. 21, 2005

(51) Int. Cl. G03B 27/42

(52) U.S. Cl. 355/53

(57) ABSTRACT

An exposing machine of the present invention consists of a plurality of ultraviolet light tubes arranged on light generation assemblies. Each tube of the ultraviolet tubes is mutually parallel and is in parallel with a printed circuit board. Accordingly, a uniformly parallel projection light can be generated for the entire printed circuit board to achieve a best exposing effect. In addition, each ultraviolet light tube which consumes power between 40 W and 150 W can generate a ultraviolet ray with an energy wavelength between 360 and 440, which is not only best suited for an exposing operation for a printed circuit board, but also can decrease a working temperature from an entire light generator assembly, along with a longer lifetime for each ultraviolet tube, thereby significantly reducing a manufacturing and maintenance cost for an exposing machine.

### BACKGROUND OF THE INVENTION

a) Field of the Invention

The present invention relates to an exposing technique for a printed circuit board, and more particularly to an improvement of an exposing machine thereof, so as to provide an exposing machine for a printed circuit board with high efficiency, long lifetime, and lower cost of manufacturing and maintenance.

b) Description of the Prior Art

Referring to FIG. 1, it shows a schematic view of a basic structure for a conventional exposing machine for a printed circuit board, wherein the exposing machine comprises primarily a machine 10 upon which installed a transmission assembly 20. The transmission assembly 20 can use a chain 21 and wheels 22 to drive two clipping frames 23 to enter and exit an open area in front of the machine 10, so as to use the clipping frames 23 as carriers for transmitting a printer circuit board (not shown in the drawing). At the same time that one clipping frame 23 transmits the printed circuit board into the machine 10 for exposing, the other clipping frame 23 is located at the open area in front of the machine 10, to facilitate an operator (or other related operating tool) to take the printed circuit board out of the clipping frame 23, and put another printed circuit board required to be exposed into the clipping frame 23, thereby achieving the object of continuously finishing.

The aforementioned exposing machine for the printed circuit board is equipped with a light generation assembly 30 inside the machine 10 for projecting a light on the printed circuit board. A conventional light generation assembly 30 uses high wattage light tubes 31 as shown in FIG. 2 as light emitting elements. As light emitted from the high wattage light tubes 31 as shown in the drawing is not in parallel, another series of optical elements 32 needs to be used to parallel project light on the printed circuit board, as shown in FIG. 1, so as to generate an uniform light projection for the entire printed circuit board. However, in addition to that the effect of parallel light from this design is limited, the entire exposing machine also needs more space for projecting the light, and the structure of entire exposing machine is complex and expensive due to the installation of complex optical elements 32.

Moreover, although some high wattage light tubes nowadays can be finished to a shape of straight tube, after all the preheating time for the high wattage light tubes is too long, thereby consuming more power and generating higher temperature. Therefore, these light tubes are only suitable for the design of a single high wattage light tube installed in the same working area. Although an amount of optical elements can be reduced in part, a quality of parallel light cannot be increased significantly, and even a complex heat dissipating equipment is still required in order to decrease a temperature loading of the high wattage light tubes. Therefore, the issues derived from the use of high wattage light tubes in the conventional exposing machine for the printed circuit board still cannot be solved.

### SUMMARY OF THE INVENTION

Accordingly, in the present invention, a plurality of ultraviolet light tubes is installed on a light generation assembly of an exposing machine. Each tube of the ultraviolet light tubes is mutually parallel and is also parallel with the printed circuit board. Accordingly, a uniformly parallel projection light can be generated for the entire printed circuit board through the uniformly arranged ultraviolet light tubes, and thus achieving a best exposing effect. Moreover, each ultraviolet light tube which consumes power between 40 W and 150 W can generate an ultraviolet ray with an energy wavelength between 360 and 440, which is not only best suitable for an exposing operation for the printed circuit board, but also generates a lower working temperature from the entire light generator, along with a longer lifetime for each of the ultraviolet light tubes, thereby significantly reducing a manufacturing and maintenance cost for the exposing machine.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of basic structure of a conventional exposing machine for a printed circuit board.

FIG. 2 shows a schematic view of appearance of a high wattage tube used in a conventional exposing machine for a printed circuit board.

FIG. 3 shows a schematic view of appearance of an exposing machine of the present invention.

FIG. 4 shows a cross sectional view of assembling structure of an exposing machine of the present invention.

FIG. 5 shows a schematic view of appearance of a light generation assembly of an exposing machine of the present invention.

FIG. 6 shows a schematic sectional view of appearance of an ultraviolet light tube of a first implementation of the present invention.

FIG. 7 shows a schematic view of appearance of an ultraviolet light tube of a second implementation the present invention.

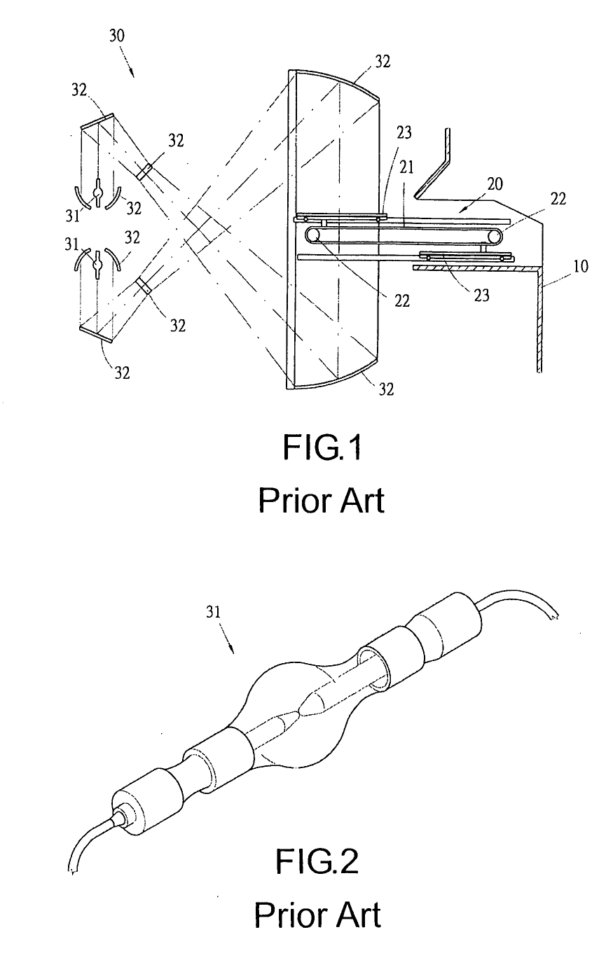

### DETAILED DESCRIPTION OF THE PREFERRED EMBODIMENTS

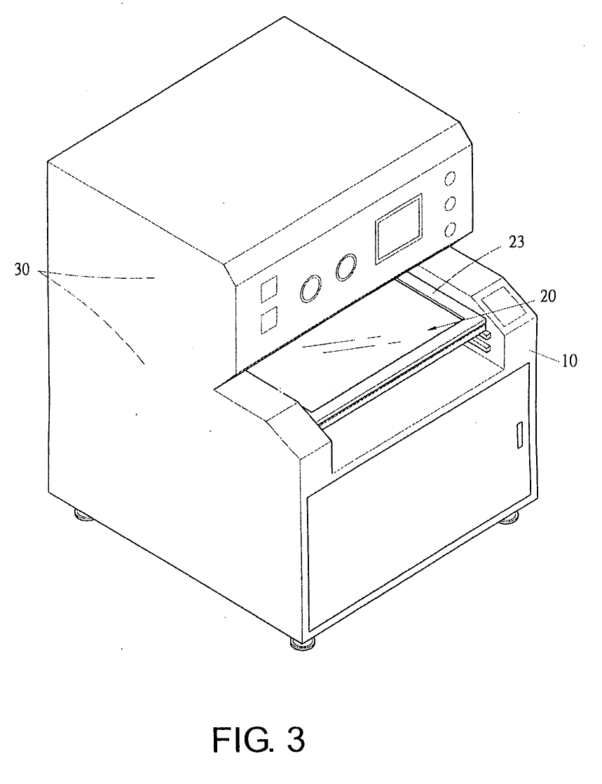

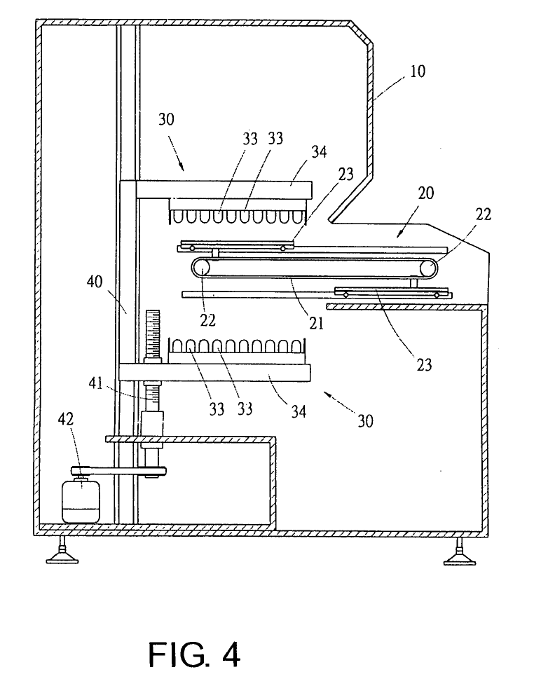

Referring to FIG. 3 and FIG. 4, it shows a basic structure of an entire exposing machine of the present invention, which consists of a machine 10 as a primary structure with an open area installed in front of the machine 10 as a feed-in/return space for a printed circuit board. In addition, related light generation assemblies 30 and a transmission assembly 20 are installed inside the machine 10. In implementing the present invention, the transmission assembly 20 extends between the open area in front of the machine 10 and an interior area of the machine 10 by a looping chain 21. Clipping frames 23 used as carriers of the printed circuit board are located at corresponding positions to an upper and lower section of the chain 21, and are iteratively moving at a specified speed and time through the chain 21 driven by wheels 22, so as to drive two clipping frames 23 to enter and exit the open area in front of the machine 10.

The aforementioned light generation assemblies 30 are installed at corresponding positions to an upper and lower section of the chain 21, respectively. When one clipping frame 23 transmits a printed circuit board to an interior of the machine 10 for exposing, another clipping frame 23 is in the open area in front of the machine 10, to facilitate an operator (or other related operating tool) to take the printed circuit board out of this clipping frame 23, and put another printed circuit board required to be exposed into this clipping frame 23, so as to achieve an object of continuously finishing.

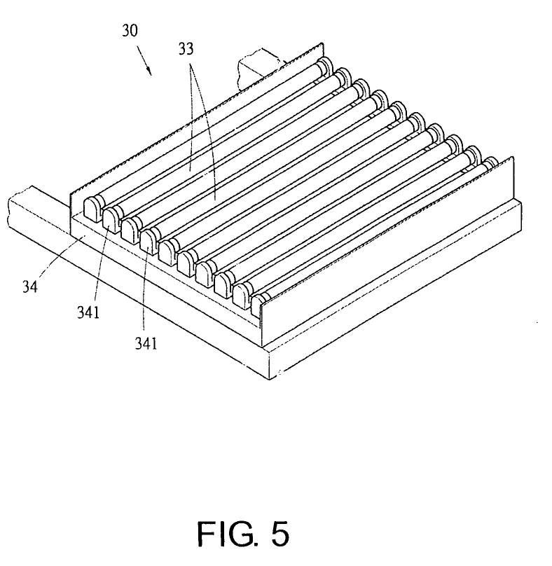

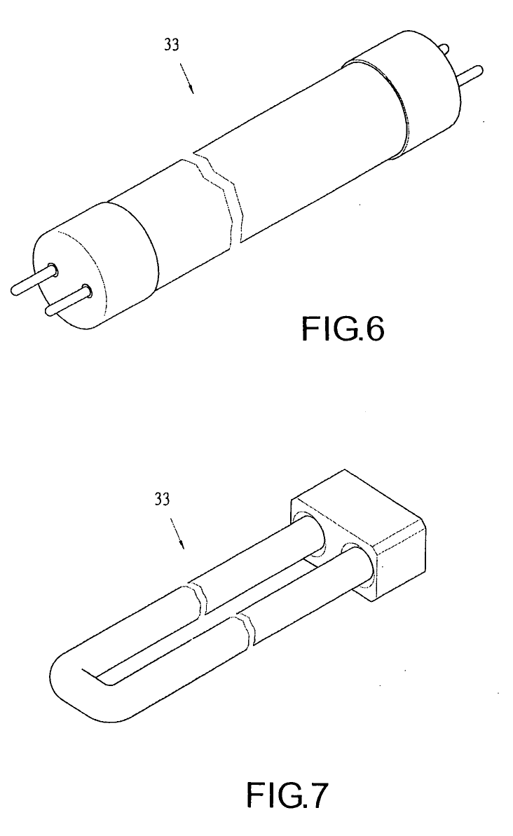

On the other hand, a main point of the present invention is that a plurality of ultraviolet light tubes 33 are arranged on each set of the light generation assemblies 30. Each tube of the ultraviolet light tubes is mutually parallel and is parallel with a printed circuit board. Upon implementing the present invention, as shown in FIG. 4 and FIG. 5, each set of light generation assemblies 30 uses a platform 30 which is parallel with a clipping frame 23 (i.e., a printed circuit board) as a main structure, and a plurality of lamp seats 341 is installed on the platform 34 with a specified pitch, in order to install ultraviolet light tubes 33 with each lamp seat 341. Moreover, the ultraviolet light tubes 33 can be in a shape of straight tube (a fluorescent light tube) as shown in FIG. 6, or in a loop shape (a PL light tube) as shown in FIG. 7, which can all achieve an effect of generating a uniformly parallel light for an entire section of the light tube. As shown in FIG. 5, through the installation of the lamp seat 341, it is convenient to assemble and exchange each ultraviolet light tube 33, so as to generate a uniformly parallel projection light for an entire printed circuit board through uniformly installing the ultraviolet light tubes 33, thereby achieving a best exposing effect. Moreover, each ultraviolet light tube 33 which consumes power between 40 W to 150 W can generate a ultraviolet ray with an energy wavelength between 360 to 440, which is not only best suited for exposing operation for a printed circuit board, but also decreases a working temperature from an entire light generator, along with a longer lifetime for each ultraviolet light tube, thereby significantly reducing a manufacturing and maintenance cost for the exposing machine.

It is worth mentioning that in an implementation as shown in FIG. 4, the light generator assemblies 30 located at corresponding upper and lower positions can be simultaneously fixed on a frame 40 which is screwed by a vertical lead screw 41. Another motor 42 is used to drive the lead screw to rotate clockwise and counterclockwise, so as to move the entire frame 40 upward and downward by the lead screw 41, thereby changing a relative distance between the light generator assemblies 30 and the clipping frames 23, and adjusting a distance of light projected on the printed circuit board, in order to achieve a best exposing effect for the printed circuit board.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An exposing machine for a printed circuit board with light generation assemblies installed inside a machine, wherein a plurality of ultraviolet light tubes is arranged on the light generation assemblies, and each tube of the ultraviolet light tubes is mutually parallel and is in parallel with a printed circuit board.

2. The exposing machine for a printed circuit board according to claim 1, wherein an open area is installed in front of the machine as a feed-in/return space for a printed circuit board, and a transmission assembly is installed inside the machine for transmitting a printed circuit board to move between the open area in front of the machine and an interior area of the machine.

3. The exposing machine for a printed circuit board according to claim 2, wherein the transmission assembly extends between the open area in front of the machine and the interior area of the machine by a looping chain, with clipping frames installed at corresponding positions to an upper and lower section of the chain as carriers for the printed circuit board and iteratively moved at specified speed and time through the chain driven by wheels, thereby driving two clipping frames to enter and exit the open area in front of the machine.

4. The exposing machine for a printed circuit board according to claim 3, wherein light generation assemblies are installed at corresponding positions to an upper and lower section of the chain inside the machine.

5. The exposing machine for a printed circuit board according to claim 3, wherein light generation assemblies are installed at corresponding positions to an upper and lower section of the chain inside the machine, and the light generation assemblies are simultaneously fixed on a frame which is screwed by a vertical lead screw, with another motor to drive the lead screw to rotate clockwise and counterclockwise.

6. The exposing machine for a printed circuit board according to claim 1, wherein the light generation assemblies use a platform which is in parallel with a printed circuit board as a main structure, with a plurality of lamp seats installed on the platform at a specified pitch.

7. The exposing machine for a printed circuit board according to claim 1, wherein the ultraviolet light tubes are in a shape of straight tube.

8. The exposing machine for a printed circuit board according to claim 1, wherein the ultraviolet light tubes are in a shape of loop.
